(19) United States
(12) Patent Application Publication
(10) Pub. No.: US 2010/0059636 A1
(43) Pub. Date: Mar. 11, 2010

(54) Water Hose Positioning Device

(76) Inventors: George H. McClanahan, Grandbury, TX (US); Jeffery McClanahan, Grandbury, TX (US)

Correspondence Address: HARSHAW RESEARCH, INC., 210 W. TECUMSEH STREET, OTTAWA, KS, 66067, US

(21) Appl. No.: 12/208,979

(22) Filed: Sep. 11, 2008

(51) Int. Cl. B05B 15/06

(52) U.S. Cl. 248/75

(57) ABSTRACT

A water hose end positioning device according to the present invention includes a first loop configured to be coupled to a spigot. An adjustable loop is configured to encircle a portion of a water hose coupled to the spigot and to contract when the portion of said water hose is under tension to inhibit the water hose from kinking between the adjustable loop and the spigot. The positioning device includes a flexible elongate length element extending between the first loop and the adjustable loop.

### BACKGROUND OF THE INVENTION

This invention relates generally to hose accessories and, more particularly, to a water hose positioning device that maintains an end of a garden hose in a straight and stabilized configuration when attached to a spigot so as to prevent damage to the hose end.

Garden hoses are subject to damage when attached to a spigot. Specifically, tugging too vigorously on an attached hose end may cause the threads on the end of the hose to become bent or for the hose to actually weaken or tear. Pressure exerted upon an attached hose end may be the result of a user trying to stretch the hose to its maximum length from the spigot or because a user is attempting to shake kinks from the hose. In either case, the fragile end of the hose is frequently damaged during normal use.

Various devices have been proposed in the art for holding a hose in a storage configuration or even for holding a hose accessory, such as a sprayer, when not in use. Although assumably effective for their intended purposes, the existing devices do not maintain a hose end in a straight or stabilized configuration while attached to a spigot so as to protect the hose end from damage.

Therefore, it would be desirable to have a water hose positioning device that keeps a hose end straight and stabilized while coupled to a spigot so as to prevent the hose end from become damaged. Further, it would be desirable to have a water hose end positioning device that is easy to install and use.

### SUMMARY OF THE INVENTION

A water hose end positioning device according to the present invention includes a first loop configured to be coupled to a spigot. An adjustable loop is configured to encircle a portion of a water hose coupled to the spigot and to contract when the portion of said water hose is under tension to inhibit the water hose from kinking between the adjustable loop and the spigot. The positioning device includes a flexible elongate length element extending between the first loop and the adjustable loop.

Therefore, a general object of this invention is to provide a water hose end positioning device for protecting the hose end from damage.

Another object of this invention is to provide a water hose end positioning device, as aforesaid, that prevents kinking between an adjustable loop and a spigot.

Still another object of this invention is to provide a water hose end positioning device, as aforesaid, that is easy to use and cost-effective to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a traditional hose end attached to a spigot according to the prior art;

FIG. 2 is a perspective view of a water hose end positioning device according to a preferred embodiment of the present invention;

FIG. 3 is a perspective view of the hose end positioning device as in FIG. 2 in use with a water hose coupled to a spigot; and

FIG. 4 is a perspective view on an enlarged scale of a portion of the hose end positioning device as in FIG. 3.

### DESCRIPTION OF THE PREFERRED EMBODIMENT

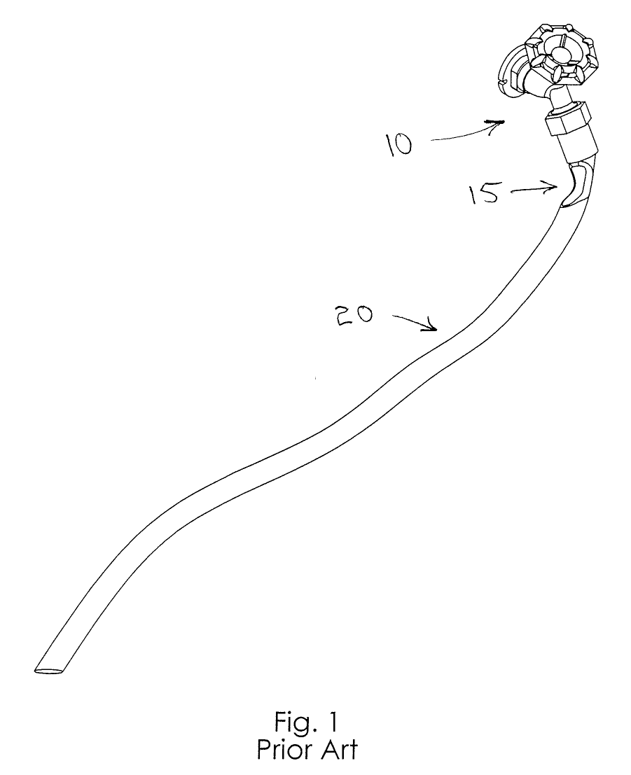

A water hose positioning device will now be described in detail with reference to FIG. 1 through FIG. 4 of the accompanying drawings. More particularly, a water hose positioning device 100 includes an elongate length element 110 and two loops 120, 130.

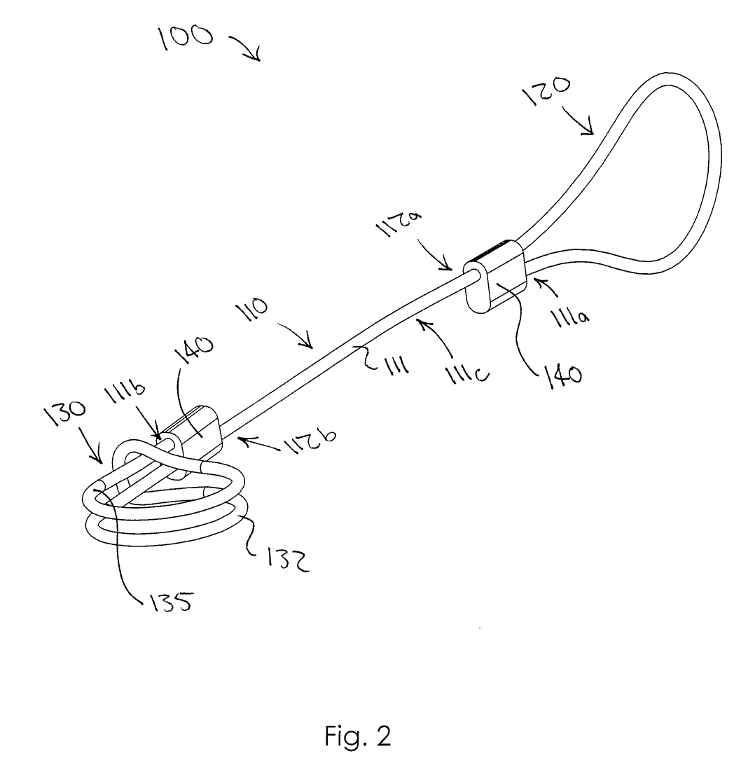

As shown in FIGS. 2, the elongate length element 110 has opposed ends 112a, 112b and may be flexible. In some embodiments, at least one flexible cable 111 forms the length element 110. Appropriate flexible cables 111 include, for example, braided stainless steel cables, flexible molded plastic straps, flexible extruded plastic straps, and other metal and non-metal cables.

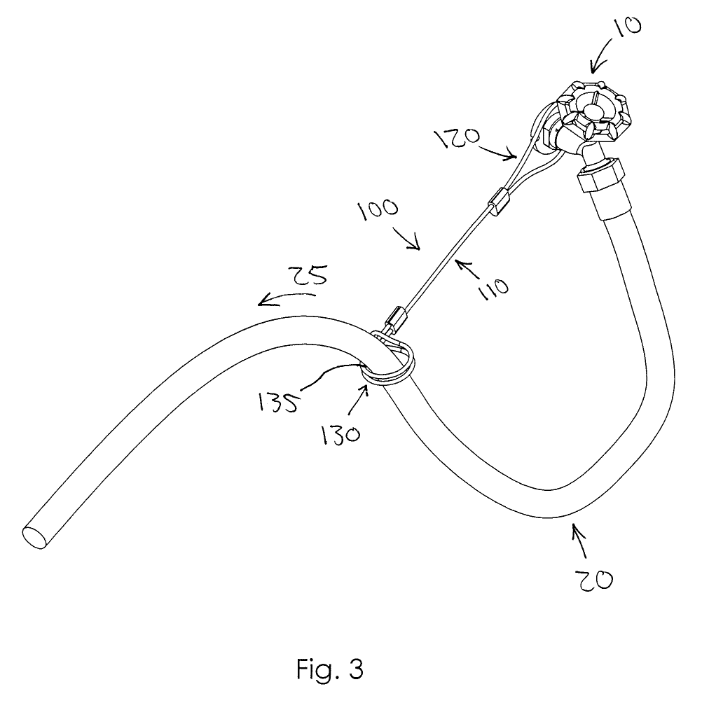

The loop 120 is at the end 112a of the length element 110 and is configured to be coupled to a spigot 10, as shown in FIG. 3. As shown in FIG. 2, the flexible cable 111 that forms the length element 110 may also form the loop 120. More particularly, the flexible cable 111 may include first and second ends 111a, 111b and have an intermediate section 111c between the ends 111a, 111b, and the first end 111a may be coupled to the intermediate section 111c to form the loop 120. The first end 111a may be coupled to the intermediate section 111c by a ferrule 140, adhesive, and/or any other appropriate coupling device or method.

The loop 130 is at the end 112b of the length element 110 and is an adjustable loop. As shown in FIG. 3, the adjustable loop 130 is configured to surround a portion of a water hose 20 that is coupled to the spigot 10, and to contract when the portion of the water hose 20 is under tension to inhibit the water hose 20 from kinking (as at 15 in FIG. 1) between the adjustable loop 130 and the spigot 10. As shown in FIG. 2, the flexible cable 111 that forms the length element 110 may also form the adjustable loop 130. More particularly, to form the adjustable loop 130, the second end 111b of the cable 111 may be coupled to the intermediate section 111c (e.g., by a ferrule 140, adhesive, etc.) to form a closed perimeter 132 at the end 112b of the length element 110, and the closed perimeter 132 may be configured as a lark's head knot (FIG. 2). While there may be manufacturing and cost advantages to using a single cable 111 for the length element 110, the loop 120, and the adjustable loop 130, it should be appreciated that multiple elements may instead be used.

A surface 135 of the adjustable loop 130 that interacts with the water hose 20 may have sufficient resistance to relative motion to impart tension on the adjustable loop 130 when the water hose 20 is under tension (i.e., when the water hose 20 is moved in direction 25 in FIG. 3). Cables 111 that do not inherently include such a resistance may be coated with plastic and/or rubber to achieve such a resistance, and coatings may further be used to improve weathering properties or for other purposes.

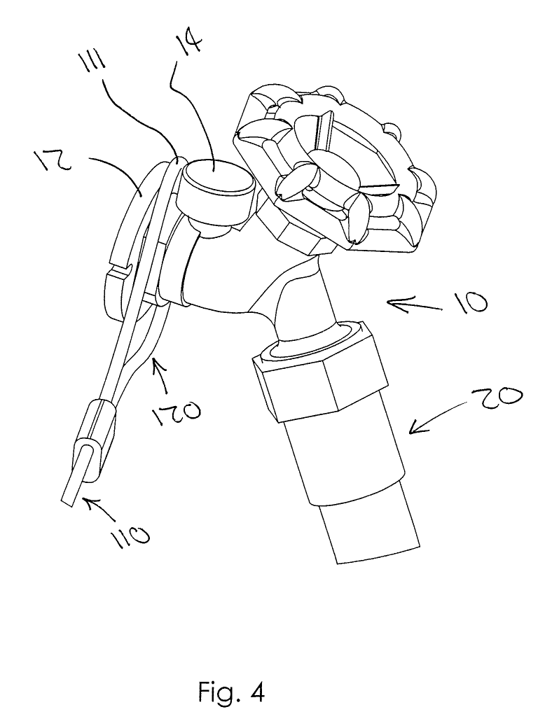

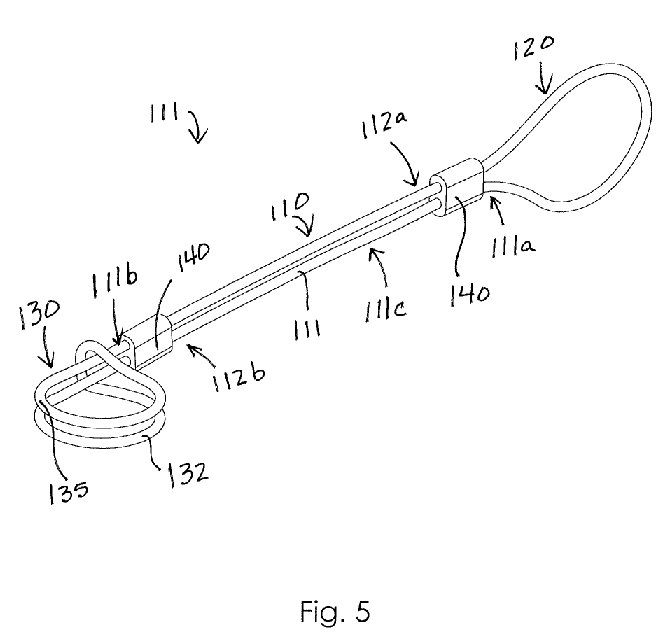

Various dimensions may be appropriate for the elements of the water hose positioning device 100, depending on construction materials, intended environmental factors (e.g., for use with a garden hose 20 or for use with a fire hose 20, for occasional use or for frequent use, etc.), and other factors. In other words, the present invention may be used with small or very large hoses so long as adequate materials and proportionate size variations are taken into account. The embodiment shown in FIGS. 2 and 3 has a length element 110 of from about five inches to about ten inches long, and the diameter (i.e., thickness) of the cable 111 in the embodiment shown in FIGS. 2 and 3 is from about 1/16 inch to about ⅛ inch. As shown in FIG. 4, the spigot 10 may include a wall plate 12 and a vent cap 14, and the flexible cable 111 at the loop 120 may be sized to fit between the wall plate 12 and the vent cap 14.

In use, the loop 120 is coupled to the spigot 10 and the hose 20 is coupled to the spigot 10, as shown in FIG. 3. The hose 20 is passed through the adjustable loop 130, and the length element 110 extends between the loop 120 and the adjustable loop 130 (FIG. 3). It may be preferable to pass the hose 20 through the adjustable loop 130 and couple the loop 120 to the spigot 10 before coupling the hose to the spigot 10, though such order is not required. When the hose 20 is pulled in direction 25 (FIG. 3), friction between the adjustable loop surface 135 and the hose 20 may cause the adjustable loop 130 to contract and grip the hose 20. Because the adjustable loop 130 gripping the hose 20 is anchored to the spigot 10, the hose 20 may be kept from kinking between the adjustable loop 130 and the spigot 10 (i.e., near the spigot 10). FIG. 1 shows such kinking (see reference number 15) that may be experienced if the device 100 is not used (and that may be avoided if the device 100 is used as set forth herein).

It is understood that while certain forms of this invention have been illustrated and described, it is not limited thereto except insofar as such limitations are included in the following claims and allowable functional equivalents thereof.

1. A water hose positioning device, comprising:
an elongate length element having opposed ends;
a first loop at one said end configured to be coupled to a spigot; and
an adjustable loop at said other end configured to surround a portion of a water hose coupled to said spigot and contract when said portion of said water hose is under tension to inhibit said water hose from kinking between said adjustable loop and said spigot;
wherein a single flexible cable having first and second ends forms said elongate length element, said first loop, and said adjustable loop, said flexible cable having an intermediate section between said first and second ends;
a ferrule coupling said first end to said intermediate section; and
another ferrule coupling said second end to said intermediate section;
said first end is coupled to said ferrule to form said first loop; and
wherein said second end is coupled to said another ferrule to form said adjustable loop;
wherein said flexible cable is configured as a lark's head knot to form said adjustable loop.

2. (canceled)

3. (canceled)

4. (canceled)

5. (canceled)

6. The device of claim 1, wherein:
said spigot includes a wall plate and a vent cap; and
a diameter of said flexible cable at said first loop is sized to fit between said wall plate and said vent cap.

7. The device of claim 1, wherein:
said flexible cable is braided stainless steel coated with at least one of plastic and rubber;
said flexible cable has a diameter from about 1/16 inch to about ⅛ inch; and
a length of said flexible cable between said first loop and said adjustable loop is from about 5 inches to about 10 inches.

8. (canceled)

9. (canceled)

10. The device of claim 1, wherein:
a flexible cable defines a closed perimeter; and
said closed perimeter is configured as a lark's head knot to form said adjustable loop.

11. The device of claim 10, wherein said elongate length element includes more than one flexible cable.

12-19. (canceled)

20. The device of claim 1, wherein a surface of said adjustable loop interacting with said water hose portion includes a rubber coating that imparts resistance to relative motion to impart tension on said adjustable loop when said water hose portion is under tension.
